(19) United States
(12) Patent Application Publication
(10) Pub. No.: US 2014/0297720 A1
(43) Pub. Date: Oct. 2, 2014

(54) CLIENT APPARATUS, SERVER APPARATUS, MULTIMEDIA REDIRECTION SYSTEM, AND METHOD THEREOF

(71) Applicant: SAMSUNG ELECTRONICS CO., LTD., Suwon-si (KR)

(72) Inventors: Hyun-sig LIM, Suwon-si (KR); Jin-hwan CHOI, Suwon-si (KR)

(73) Assignee: SAMSUNG ELECTRONICS CO., LTD., Suwon-si (KR)

(21) Appl. No.: 13/961,312

(22) Filed: Aug. 7, 2013

(30) Foreign Application Priority Data
Mar. 27, 2013 (KR) 10-2013-0032786

(51) Int. Cl. H04L 29/06

(52) U.S. Cl. CPC H04L 29/06027; H04L 29/06047
USPC 709/203

(57) ABSTRACT

A client apparatus, a server apparatus, a multimedia redirection system, and a method thereof includes: a client interface which communicates with a server apparatus that supports a multimedia redirection function; a connector which is connected to a client local storage that stores a client content; a data processor which processes the client content; a controller which transmits information about the client content to the server apparatus and, if a play command with respect to the client content is received from the server apparatus, controls the data processor to process the client content as a form that is output; and an output unit which outputs the processed client content.

### CROSS-REFERENCE TO RELATED APPLICATIONS

This application claims priority under 35 U.S.C. §119 from Korean Patent Application No. 10-2013-0032786, filed on Mar. 27, 2013, in the Korean Intellectual Property Office, the disclosure of which is incorporated herein by reference in its entirety.

### BACKGROUND

1. Field

One or more embodiments relate to a client apparatus, a server apparatus, a multimedia redirection system, a method thereof, and more particularly, to a client apparatus which may play a client content stored in a client according to a play command of a server to perform a multimedia redirection, a server apparatus, a multimedia redirection system, and a method thereof.

2. Description of the Related Art

A multimedia redirection refers to a technology by which a server does not play outputs of various types of contents, such as an image, a moving picture, a sound, etc., and then a client does not output the outputs, but the server immediately transmits a media stream of a content to the client, and the client directly plays the corresponding content.

For example, in order to output an image, which is a server media content stored in the server, through the client, the server renders and captured the image and transmits the captured image to the client. In this case, the client renders and displays the captured image. If the server media content stored in the server is a moving picture, the server transmits the moving picture that is the server media content, as a stream to the client, and the client decodes, renders, and plays the stream.

According to such a multimedia redirection method, in order to play a moving picture that is a client media content stored in a local storage of the client, the client transmits the client media content stored in the local storage of the client to the server. The server transmits the client media content as a stream to the client, and the client decodes and renders the stream to play the client media content.

However, when playing the client media content stored in the local storage of the client, the client media content is transmitted from the client to the server and then is transmitted from the server to the client. Therefore, this is inefficient.

Also, since a client moves between the client and the server, play performance is lowered by a capacity of the moving content.

### SUMMARY

Additional aspects and/or advantages of one or more embodiments will be set forth in part in the description which follows and, in part, will be apparent from the description, or may be learned by practice of one or more embodiments of disclosure. One or more embodiments are inclusive of such additional aspects.

One or more embodiments address at least the above problems and/or disadvantages and other disadvantages not described above. Also, one or more embodiments are not required to overcome the disadvantages described above, and an exemplary embodiment may not overcome any of the problems described above.

One or more embodiments relate to a client apparatus which may play a client content stored in a client according to a play command of a server to perform a multimedia redirection, a server apparatus, a multimedia redirection system, and a method thereof.

One or more embodiments relate to a client apparatus that may include: a client interface which may communicate with a server apparatus that may support a multimedia redirection function; a connector which may be connected to a client local storage that may store a client content; a data processor which may process the client content; a controller which may transmit information about the client content to the server apparatus and, if a play command with respect to the client content is received from the server apparatus, may control the data processor to process the client content as a form that is output; and an output unit which may output the processed client content.

If the client local storage is connected to the connector, the client controller may automatically extract the information about the client content and transmit the information to the server apparatus.

If a user play command with respect to the client content is input, the client controller may transmit the client content information to the server apparatus.

One or more embodiments relate to a server apparatus which may support a multimedia redirection function. The server apparatus may include: a server interface which may receive information about a content from a client apparatus to which a client local storage storing the content may be connected; and a server controller which may generate a content play command corresponding to the content based on the information about the content and may transmit the content play command to the client apparatus.

One or more embodiments relate to a multimedia redirection system that may include: a server apparatus which may perform a multimedia redirection function; and a client apparatus which may operate under control of the server apparatus. If a local storage storing a content is connected, the client apparatus may transmit information about the content to the server apparatus. The server apparatus may generate a content play command corresponding to the content based on the information about the content and may transmit the content play command to the client apparatus. If the content play command is received, the client apparatus may play and output the content stored in the local storage.

If the local storage is connected, the client apparatus may automatically extract the information about the content and may transmit the information to the server apparatus. If the information about the content is received, the server apparatus may automatically extract the content play command and may transmit the extracted content play command to the client apparatus.

The client apparatus may display a user interface (UI) screen displaying the content information stored in the local storage if the local storage is connected and may transmit the content information to the server apparatus if a user play command with respect to the content is input on the UI screen.

One or more embodiments relate to a multimedia redirection method in a multimedia redirection system. The multimedia redirection method may include: if a client local storage storing a client content is connected to a client apparatus, detecting information about the client content through the client apparatus; transmitting the information from the client apparatus to a server apparatus; generating a play command with respect to the client content based on the information through the server apparatus; transmitting the play command from the server apparatus to the client apparatus; and playing the client content according to the play command through the client apparatus.

One or more embodiments relate to a multimedia redirection method of a client apparatus. The multimedia redirection method may include: if a client local storage storing a client content is connected, detecting information about the client content; transmitting the information to a server apparatus that supports a multimedia redirection function; receiving a content play command corresponding to the information from the server apparatus; and processing and outputting the client content according to the content play command.

One or more embodiments relate to a multimedia redirection method of a server apparatus which supports a multimedia redirection function. The multimedia redirection method may include: receiving information about a content from a client apparatus to which a client local storage storing the content is connected; generating a content play command corresponding to the content based on the information about the content; and transmitting the content play command to the client apparatus.

### BRIEF DESCRIPTION OF THE DRAWINGS

These and/or other aspects will become apparent and more readily appreciated from the following description of embodiments, taken in conjunction with the accompanying drawings of which:

FIG. 1 is a block diagram of a multimedia redirection system according to one or more embodiments;

FIG. 2 is a timing diagram illustrating a multimedia redirection method according to one or more embodiments;

FIG. 3 is a block diagram of a client apparatus according to one or more embodiments;

FIG. 4 is a flowchart illustrating a multimedia redirection method in a client apparatus, according to one or more embodiments;

FIG. 5 is a block diagram of a client apparatus according to one or more embodiments;

FIG. 6 is a block diagram of a server apparatus according to one or more embodiments;

FIG. 7 is a flowchart illustrating a multimedia redirection method in a server apparatus, according to one or more embodiments;

FIG. 8 is a flowchart illustrating a multimedia redirection method in a server apparatus, according to one or more embodiments; and

FIG. 9 is a view illustrating a multimedia redirection system according to one or more embodiments.

### DETAILED DESCRIPTION

Reference will now be made in detail to one or more embodiments, illustrated in the accompanying drawings, wherein like reference numerals refer to like elements throughout. In this regard, embodiments of the present invention may be embodied in many different forms and should not be construed as being limited to embodiments set forth herein, as various changes, modifications, and equivalents of the systems, apparatuses and/or methods described herein will be understood to be included in the invention by those of ordinary skill in the art after embodiments discussed herein are understood. Accordingly, embodiments are merely described below, by referring to the figures, to explain aspects of the present invention.

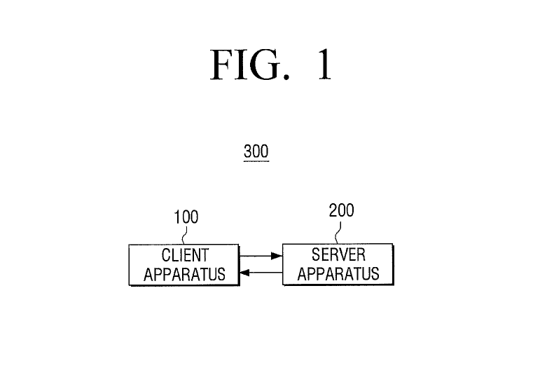

FIG. 1 is a block diagram of a multimedia redirection system 300 according to one or more embodiments.

In general, a multimedia redirection refers to a technology which is to directly transmit a multimedia stream to a client by using a virtual channel, i.e., which is to encode and decode the multimedia stream in a client apparatus to process the multimedia stream. In this case, the client apparatus supports an operating system (OS) such as Windows XP, Windows XP Embedded, Windows Vista, or the like.

Referring to FIG. 1, the multimedia redirection system 300 of the present exemplary embodiment may include a client apparatus 100 and a server apparatus 200.

The client apparatus 100 may remotely access the server apparatus 200 to output a client content stored in a client local storage and may be a terminal used by a user. In this case, the client local storage may be connected to the client apparatus 100. If the client local storage is connected to the client apparatus 100, the client apparatus 100 may automatically extract information about the client content, i.e., client content information, and may transmit the information to the server apparatus 200 that supports a multimedia redirection function. In this case, the server apparatus 200 that has received the information about the client content may automatically extract a client play command that is a play command with respect to the client content and may transmit the client play command to the client apparatus 100. If a user play command with respect to the client content is input, the client apparatus 100 may transmit the client content information that is the information about the client content, to the server apparatus 200.

An operating system that the client requires may be installed in the server apparatus 200 to support a multimedia redirection function. Therefore, the server apparatus 200 may remotely access the client apparatus 100 to control the client apparatus 100. If the server apparatus 200 receives the client content information from the client apparatus 100, the server apparatus 200 may generate a client content play command and may transmit the client content play command to the client apparatus 100.

The client apparatus 100 and the server apparatus 200 may access each other through an IP network.

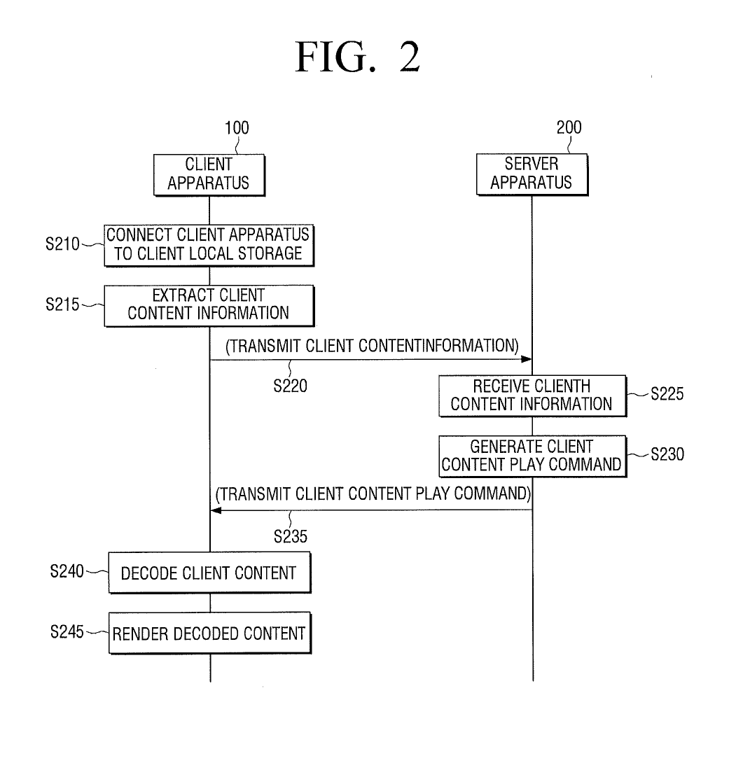

FIG. 2 is a timing diagram illustrating a multimedia redirection method according to one or more embodiments.

Referring to FIG. 2, in operation S210, the client apparatus 100 may be connected to a client local storage. In operation S215, the client apparatus 100 may extract client content information.

If the client apparatus 100 is connected to the client local storage in operation S210, the client apparatus 100 may automatically extract the client content information in operation S215. Alternatively, when the client apparatus 100 is connected to the client local storage, and a user play command to play a client content is input, the client apparatus 100 may be realized in a form that extracts client content information.

The client content information may be extracted from metadata that may be stored along with a content in the client local storage. In detail, the client content information may include various types of information such as a type, a size, an encoding method, a file name, a program code, a file extension, etc. of the content.

If the client content information is extracted in operation S215, the client apparatus 100 may transmit the client content information to the server apparatus 200 in operation S220. In operation S225, the server apparatus 200 may receive the client content information. In operation S230, the server apparatus 200 may generate a client content play command. In detail, a play command, a file name of an object to be played, a position coordinate value to display a content play screen, a decoding method, a color attribute value, resolution information, etc. that are defined in the multimedia redirection function may be combined to generate the content play command.

In operation S235, the server apparatus 200 may transmit the generated client content play command to the client apparatus 100.

If the client apparatus 100 receives the client content play command, the client apparatus 100 may process a corresponding content. In detail, the client apparatus 100 may decode a client content in operation S240.

In other words, if the client apparatus 100 includes a parser, a codec, etc. in a multimedia redirection system, the client apparatus 100 may directly process and play a content under control of the server apparatus 200. The parser is an element that parses a content to extract various types of information necessary for playing the content. Examples of the parser may include a moving picture parser, an image parser, an audio parser, an Extensible Mark-up Language (XML) parser, etc. The codec is an element that encodes or decodes a data stream or signal. Examples of the codec may include a Moving Picture Expert Group (MPEG) codec, a Divx codec, an AC3 codec, an OGG codec, an Xvid codec, an H.264 codec, a wmv7, 8, 9 codec, a video codec, etc. The client apparatus 100 may decode the content by using the parser and the codec.

The client apparatus 100 may render the decoded content on a screen in operation S245. Rendering refers to a process of forming a visual content such as an architecture, a simulation, a move, or the like, i.e., a process of forming an image from a file by using a program. In detail, the client apparatus 100 may render a content play screen in a screen position designated by the content play command transmitted from the server apparatus 200.

The client apparatus 100 may perform various types of additional processing. For example, if a display resolution of the client apparatus 100 is higher than an original resolution of a content, the client apparatus 100 may interpolate the resolution of the content to adjust the resolution of the content with the display resolution of the client apparatus 100. Alternatively, if an aspect ratio of a display panel of the client apparatus 100 is different from an aspect ratio of the content, the client apparatus 100 may perform cropping according to a ratio of a display unit of the client apparatus 100. The client apparatus 100 may reduce a resolution or adjust a bit rate according to a parsing ability and a decoding ability of the client apparatus 100

As described above, a multimedia redirection function may be performed without directly receiving and transmitting a content between a server apparatus and a client apparatus. Therefore, a track burden may be reduced, and the content may be efficiently played.

A client apparatus that performs the multimedia redirection function described with reference to FIGS. 1 and 2 may be realized as various types.

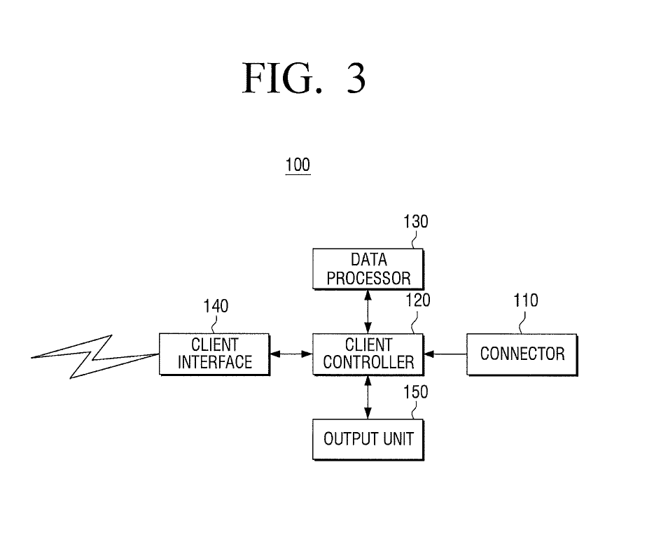

FIG. 3 is a block diagram of the client apparatus 100, according to one or more embodiments.

Referring to FIG. 3, the client apparatus 100 may include a client interface 140, a connector 110, a data processor 130, a client controller 120, and an output unit 150.

The connector 110 may be connected to a client local storage that stores a client content. The connector 110 may be connected to the client local storage to transmit the client content stored in the client local storage to the client controller 120. The client local storage may be a universal serial bus (USB) memory, an external hard disc drive (HDD), a memory card, webhard, or the like. The connector 110 may be realized as various types according to a type of the client local storage. For example, the connector 110 may be realized as a slot shape to which the USB memory may be connected.

The client controller 120 may control an overall operation of the client apparatus 100. In detail, if the client local storage is connected to the connector 110, the connector 110 may recognize the connection of the client local storage and inform the server apparatus 200 of the connection of the client local storage. The client controller 120 may extract client content information and may transmit the client content information to the server apparatus 200. As described above, the client content information may include various types of information.

The client controller 120 may transmit the client content information to the server apparatus 200 and then, if a play command to play a content, i.e., a client content play command, is input from the server apparatus 200 through the client interface 140, may control the data processor 130 to process the client content as a form that may be output.

The data processor 130 is an element that may process the client content. In detail, the data processor 130 may perform parsing, decoding, rendering, etc. with respect to a content. The data processor 130 may process the content by using an appropriate parser and an appropriate codec according to the play command transmitted from the server apparatus 200.

The output unit 150 is an element that may output the client content. The output unit 150 may include various types of output devices such as a display panel, a speaker, a headset port, etc. A video frame processed by the data processor 130 may be output through the display panel of the output unit 150, and an audio signal processed by the data processor 130 may be output through the speaker, the headset port or the like.

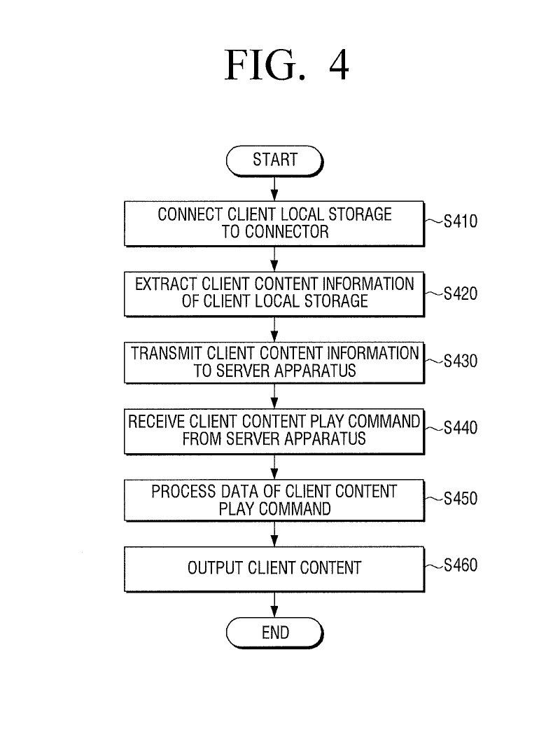

FIG. 4 is a flowchart illustrating a multimedia redirection method in a client apparatus according to one or more embodiments.

Referring to FIG. 4, in operation S410, the client apparatus may be connected to a client local storage. In operation S420, the client apparatus may extract client content information from the client local storage. The client apparatus may be connected to the client local storage in operation S410, and the client local storage may be connected to a connector of the client apparatus to extract the client content information in operation S420. The client content information may include various types of information such as a type, a size, an encoding method, a file name, a program code, etc. of a client content. In this case, the client apparatus may recognize the client content information to convert the client content information into transmission data, and the transmission data may be converted from the client content information so that a server apparatus recognizes the transmission data.

In operation S430, the client apparatus may transmit the extracted client content information to the server apparatus. The various types of information, such as the type, the size, the encoding method, the file name, the program code, etc. of the client content, that is the client content information may be extracted and then transmitted to the server apparatus through a client interface. Also, the client interface and the server apparatus may communicate with each other through an IP network. In this case, the server apparatus may receive the client content information and then generate a client content play command to play the client content.

If the client apparatus transmits the client content information to the server apparatus in operation S430, the client apparatus may receive the client content play command from the server apparatus in operation S440. The client content play command is a signal of the server apparatus which is to play the client content in the client apparatus and may be transmitted from the server apparatus to the client interface through the IP network.

If the client apparatus receives the client content play command from the server apparatus in operation S440, the client apparatus may process data of the client content play command in operation S450 and may output the client content in operation S460. The processing of the data may refer to decoding and rendering of an encoded client content. The client apparatus may recognize the received client content play command and convert the client content play command into reception data, and the reception data may be converted from the client content play command received from the server apparatus so that the client apparatus may recognize the reception data. The client apparatus may output or play the client content according to the client content play command, the data of which may have been processed, in operation S460. As a result, a user may experience the client content.

A multimedia redirection function that may be performed when a client apparatus is connected to an external local storage has been described above. However, a content stored in an internal storage of the client apparatus may also be played.

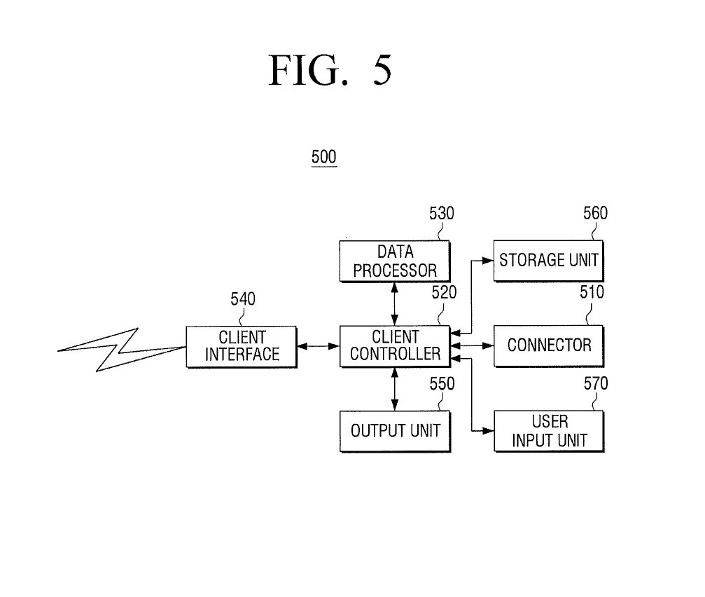

FIG. 5 is a block diagram of a client apparatus 500 according to one or more embodiments.

Referring to FIG. 5, the client apparatus 500 may include a client interface 540, a connector 510, a data processor 530, a client controller 520, an output unit 550, a storage unit 560, and a user input unit 570. The storage unit 560 may be realized as an HDD, a flash memory, or the like. A content stored in an external local storage connected through the connector 510 of the client apparatus 500 may be copied into the storage unit 560 or a content downloaded from a web server, other external apparatuses, or the like may be stored in the storage unit 560.

If a new content is stored in the storage unit 560, the client controller 520 may transmit information about the new content to the server apparatus 200 automatically or according to a user command.

The user input unit 570 is an element that may receive various types of user commands. The user input unit 570 may be realized as various types according to a type of the client apparatus 500. For example, the user input unit 570 may include various types of input means such as a mouse, a keyboard, a touch pad, a button, etc. A user may control the user input unit 570 by viewing various types of user interface (UI) screens displayed on a screen of the output unit 550, to input various types of user commands.

The user input unit 570 may form a single body along with a display panel of the output unit 550 to be realized as a touch screen type. In this case, the user may directly touch the screen to input the user commands.

Alternatively, the user input unit 570 may include a camera, a microphone, or the like. In this case, the user may input the user commands according to a motion input method or a voice input method.

If a new content is stored in the storage unit 570 or the local storage storing a content is connected to the connector 510, the client controller 520 may control the output unit 550 to display a UI screen displaying information about the corresponding content. The user may input a play command with respect to the content displayed on the UI screen through the user input unit 570. In this case, the client controller 520 may transmit information about a selected content to the server apparatus 200 through the client interface 540. Therefore, if the play command is received, the data processor 530 may play the content according to the play command and may output the content through the output unit 550.

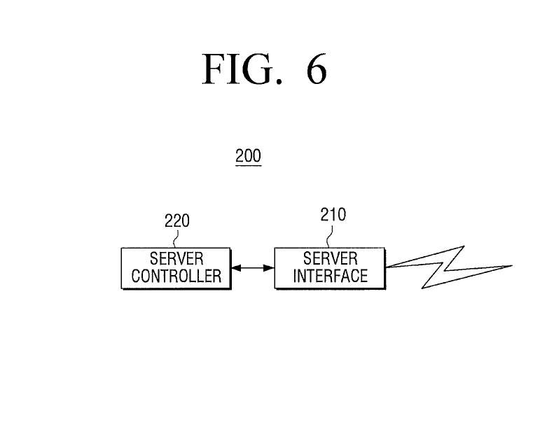

FIG. 6 is a block diagram of a server apparatus 200, according to one or more embodiments.

Referring to FIG. 6, the server apparatus 200 may support a multimedia redirection function and may include a server interface 210 and a server controller 220.

In the server apparatus 200 that supports the multimedia redirection function, the server interface 210 may receive client content information stored in a client local storage from a client apparatus to which the client local storage may be connected. In this case, the client content information may be transmitted from a client interface of the client apparatus to the server interface 210 through an IP network. The server interface 210 may transmit the received client content information to the server controller 220.

If a user play command with respect to a client content is input into the client apparatus, the server interface 210 may receive the client content information.

If the server controller 220 receives the client content information from the server interface 210, the server controller 220 may generate a client content play command. The client content play command is a signal that commands playing of the client content in the client apparatus. The client content play command may also be transmitted to the server interface 210 and then transmitted to the client apparatus. In this case, the server controller 220 may be a Mobile Multi-hop Relay (MMR) server module.

If the server interface 210 receives the client content information, the server controller 220 may generate the client content play command and may transmit the client content play command to the client apparatus. In this case, the server controller 220 may determine a decoding method based on a file extension or the like included in the client content information. The server controller 220 may also determine a pixel coordinate value, etc. that is to be displayed on a content play screen, in consideration of a size, a shape, or the like of a display panel of the client apparatus. The server controller 220 may generate a content play command including information about the determined decoding method, the pixel coordinate value, a name of a content to be played, and a control command value commanding playing of the content according to these and transmit the client play command to the client apparatus.

A server apparatus according to one or more embodiments may further include a server content storage. The server content storage may include a server content, and the server content may be transmitted to the client apparatus through a server interface under control of a server controller.

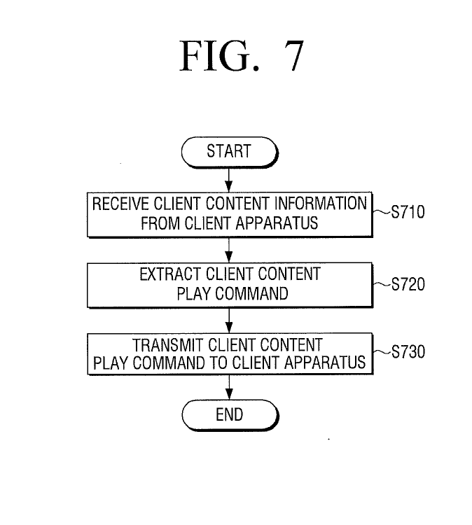

FIG. 7 is a flowchart illustrating a multimedia redirection method in a server apparatus, according to one or more embodiments.

Referring to FIG. 7, in operation S710, the server apparatus may receive client content information from a client apparatus. In this case, before the server apparatus receives the client content information, the client apparatus may input a user play command with respect to a client content. If the client apparatus inputs the user play command, the server apparatus may receive the client content information from the client apparatus. If the client apparatus inputs the user play command with respect to the client content, the server apparatus may receive the client content information, which is to be transmitted from the client apparatus, through a server interface in operation S710. In this case, the client content information may be transmitted from a client interface of the client apparatus to the server interface through an IP network, and the server interface may transmit the received client content information to a server controller.

If the server apparatus receives the client content information in operation S710, the server apparatus may extract a client content play command that commands the client apparatus to play the client content, in operation S720. The server apparatus may transmit the extracted client content play command to the server interface. In this case, if the client apparatus automatically extracts the client content information and transmits the client content information to the server apparatus, the server apparatus may automatically extract the client content play command and transmit the client content play command to the client apparatus.

If the server apparatus extracts the client content play command in operation S720, the server apparatus may transmit the extracted client content play command to the client apparatus in operation S730. In this case, the extracted client content play command may be transmitted from the server interface to the client interface through the IP network.

Besides the above-described one or more embodiments, a local storage connected to the client apparatus may be used according to various methods. For example, according to one or more embodiments, the local storage may be used as a buffer.

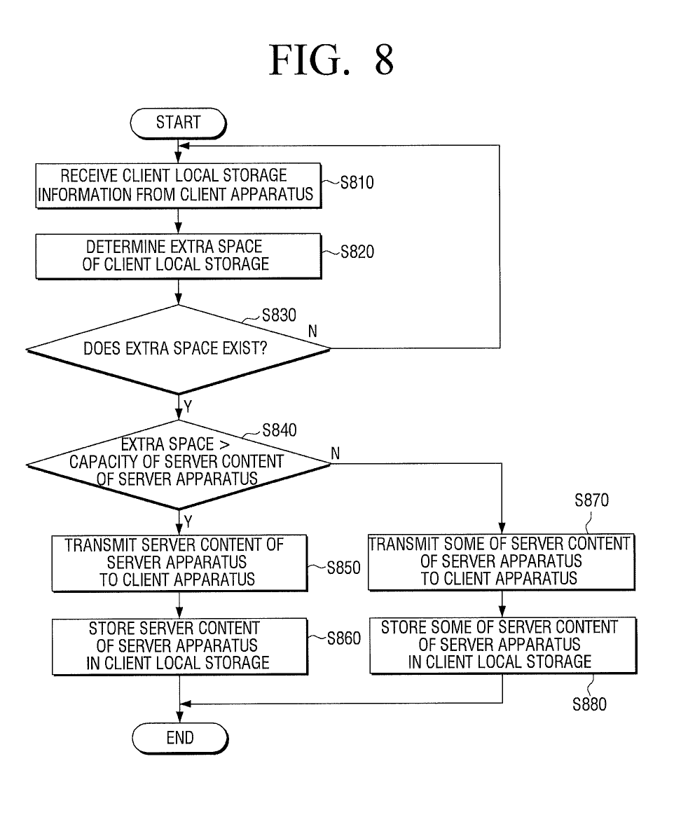

FIG. 8 is a flowchart illustrating a multimedia redirection method according to one or more embodiments.

Referring to FIG. 8, if a particular event occurs, a client apparatus may transmit information about a client local storage to a server apparatus. For example, if the local storage is connected to the client apparatus or a preset time period comes when the local storage is connected to the client apparatus, the client apparatus may transmit local storage information to the server apparatus.

In operation S810, the server apparatus may receive client local storage information from the client apparatus. In operation S820, the server apparatus may determine an extra space of the client local storage.

For example, if a total capacity of the client local storage is 10 MB, and a capacity of a client content among the total capacity of the client local storage is 7 MB, the extra space of the client local storage may be determined as 3 MB. If the client local storage does not store the client content, the extra space of the client local storage may be 10 MB. If the capacity of the client content stored in the client local storage is 10 MB, the extra space of the client local storage may be 0 MB.

In operation S830, the server apparatus may determine whether extra space of the client local storage exists. If it is determined in operation S830 that extra space of the client local storage exists, the server apparatus may determine a capacity of a server content included in a server storage to compare the extra space of the client local storage with the capacity of the server content. A server controller may differently process the server content according to whether the comparison result satisfies a preset condition. For example, various conditions may be applied. In other words, the extra space of the client local storage may preset n times (where n is a natural number) greater than the capacity of the server content, may be smaller than the capacity of the server content, and may be smaller than a total capacity of the server content and greater than a size of a decoding unit.

In FIG. 8, only two conditions are illustrated such as the extra space being greater than and smaller than the capacity of the server content. However, according to one or more embodiments, these conditions may be selective applied, and the server controller may differently process the server content according to whether the comparison result satisfies the applied conditions. If the extra space of the client local storage is greater than the capacity of the server content, the server apparatus may transmit all of the server content to the client apparatus in operation S850. In operation S860, the client apparatus may store the received server content in the client local storage.

For example, if the extra space of the client local storage is 3 MB, and the capacity of the server content is 2 MB, the server content transmitted to the client apparatus may be 2 MB.

Even if the extra space is greater than a size of the server content, a size of a transmitted content may be determined in consideration of a traffic between the server apparatus and the client apparatus. In other words, if a server traffic is lower than or equal to a preset value, all of the server content may be transmitted to the client apparatus. If the server traffic is higher than or equal to the preset value, the server content may be segmented to transmit only a portion of the contents to the client apparatus.

For example, if the server traffic is higher than or equal to the preset value when the extra space of the client local storage is 3 MB, and the capacity of the server content is 2 MB, 2/n MB of the server content may be transmitted when being transmitted one time and thus may be transmitted n times.

If the extra space of the client local storage is smaller than the capacity of the server content in operation S840, the client local storage may store all of the server content. Therefore, the server apparatus may not transmit the server content or may transmit a portion of the server content to the client apparatus. In FIG. 8, for example, the server content is segmented to transmit a few of units to the client apparatus. Here, a unit refers to unit data having a decodable size.

For example, if the extra space of the client local storage is 2 MB, the capacity of the server content is 3 MB, and the server content is decoded in the unit of 500 KB, the server apparatus may segment the server content in the unit of 500 KB and may pre-transmit the server content to the client apparatus. If content playing is performed, the server apparatus may transmit next unit data when the client apparatus processes the received server content, thereby possibly performing content playing without disconnections. As described above, even in this case, a transmission amount of the server content may be determined in consideration of a traffic.

The operations described with reference to FIG. 8 may be performed at various time points. For example, when the client apparatus and the server apparatus initially communicate with each other, the operations of FIG. 8 may be performed. Alternatively, whenever a preset time period comes after the client apparatus and the server apparatus communicate with each other, the operations of FIG. 8 may be performed. Also, the operations of FIG. 8 may be performed when a communication between the client apparatus and the server apparatus is performed for a predetermined time after the client apparatus and the server apparatus communicate with each other or when a manager of the server apparatus selects the server content and the client apparatus to input a play command to play the server content in the client apparatus. Therefore, although the server apparatus may directly transmit a content to the client apparatus to play the content, the server apparatus may pre-transmit all or a portion of the content by using a local storage. As a result, playing of the content may be achieved efficiently.

A multimedia redirection function as described above may be applied and used in various environments. For example, the multimedia redirection function may be realized with a plurality of user terminal apparatuses in which hardware and software having limited capability are installed and a multimedia redirection system controlling the plurality of user terminal apparatuses. In this case, the server apparatus may provide outputs according to user commands respectively input from the user terminal apparatuses.

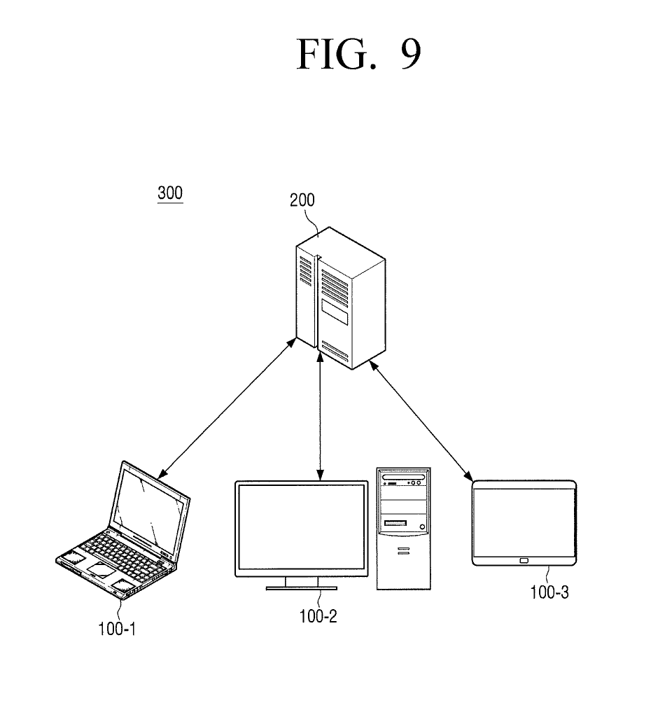

FIG. 9 is a view illustrating a multimedia redirection system 300 including a plurality of user terminal apparatuses, i.e., client apparatuses.

Referring to FIG. 9, the multimedia redirection system 300 may include a server apparatus 200 and at least one or more client apparatuses 100-1, 100-2, and 100-3 that may be remotely connected to the server apparatus 200. Three client apparatuses, for example, a laptop computer 100-1, a desktop computer 100-2, and a tablet personal computer (PC) 100-3, are illustrated in FIG. 9. However, types and the number of client apparatuses are not so limited. In this case, the client apparatuses 100-1, 100-2, and 100-3 may be connected to the server apparatus 200 through an IP network.

A user may connect local storages, such as USB memories, to the client apparatuses 100-1, 100-2, and 100-3. For example, if the USB memory is connected to the first client apparatus 100-1, the first client apparatus 100-1 may recognize the connection of the USB memory and may transmit information about a content stored in the USB memory to the server apparatus 200. Here, the information about the content may be automatically transmitted when the USB memory is connected to the first client apparatus 100-1 or when the user inputs a play command. If the information about the content is received, the server apparatus 200 may transmit the play command to the first client apparatus 100-1. Therefore, the first client apparatus 100-1 may play a content. The other client apparatuses 100-2 and 100-3 may display various types of screens processed by the server apparatus 200, separately from the first client apparatus 100-1. As described above, although content playing is requested when a multimedia redirection function is performed, a content playing function may be efficiently supported without a traffic burden.

According to the above-described one or more embodiments, when a multimedia redirection is performed, inefficiency of playing a client content may be improved, and a playing performance may be improved.

In one or more embodiments, any apparatus, system, element, or interpretable unit descriptions herein include one or more hardware devices or hardware processing elements. For example, in one or more embodiments, any described apparatus, system, element, retriever, pre or post-processing elements, tracker, detector, encoder, decoder, etc., may further include one or more memories and/or processing elements, and any hardware input/output transmission devices, or represent operating portions/aspects of one or more respective processing elements or devices. Further, the term apparatus should be considered synonymous with elements of a physical system, not limited to a single device or enclosure or all described elements embodied in single respective enclosures in all embodiments, but rather, depending on embodiment, is open to being embodied together or separately in differing enclosures and/or locations through differing hardware elements.

In addition to the above described embodiments, embodiments can also be implemented through computer readable code/instructions in/on a non-transitory medium, e.g., a computer readable medium, to control at least one processing device, such as a processor or computer, to implement any above described embodiment. The medium can correspond to any defined, measurable, and tangible structure permitting the storing and/or transmission of the computer readable code.

The media may also include, e.g., in combination with the computer readable code, data files, data structures, and the like. One or more embodiments of computer-readable media include: magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Computer readable code may include both machine code, such as produced by a compiler, and files containing higher level code that may be executed by the computer using an interpreter, for example. The media may also be any defined, measurable, and tangible distributed network, so that the computer readable code is stored and executed in a distributed fashion. Still further, as only an example, the processing element could include a processor or a computer processor, and processing elements may be distributed and/or included in a single device.

The computer-readable media may also be embodied in at least one application specific integrated circuit (ASIC) or Field Programmable Gate Array (FPGA), as only examples, which execute (e.g., processes like a processor) program instructions.

While aspects of the present invention have been particularly shown and described with reference to differing embodiments thereof, it should be understood that these embodiments should be considered in a descriptive sense only and not for purposes of limitation. Descriptions of features or aspects within each embodiment should typically be considered as available for other similar features or aspects in the remaining embodiments. Suitable results may equally be achieved if the described techniques are performed in a different order and/or if components in a described system, architecture, device, or circuit are combined in a different manner and/or replaced or supplemented by other components or their equivalents.

Thus, although a few embodiments have been shown and described, with additional embodiments being equally available, it would be appreciated by those skilled in the art that changes may be made in these embodiments without departing from the principles and spirit of the invention, the scope of which is defined in the claims and their equivalents.

What is claimed is:

1. A client apparatus comprising:
a client interface which communicates with a server apparatus that supports a multimedia redirection function;
a connector which is connectable to a client local storage that stores a client content;
a data processor which processes the client content;
a controller which transmits information about the client content to the server apparatus and controls the data processor to process the client content as a form that is output when a play command with respect to the client content is received from the server apparatus; and
an output unit which outputs the processed client content.

2. The client apparatus of claim 1, wherein if the client local storage is connected to the connector, the client controller automatically extracts the information about the client content and transmits the extracted information to the server apparatus.

3. The client apparatus of claim 1, wherein the client controller transmits the client content information to the server apparatus when a user play command with respect to the client content is input.

4. A server apparatus which supports a multimedia redirection function, the server apparatus comprising:
a server interface which receives information about a content from a client apparatus to which a client local storage storing the content is connected; and
a server controller which generates a content play command corresponding to the content based on the information about the content and transmits the content play command to the client apparatus.

5. A multimedia redirection system comprising:
a server apparatus which performs a multimedia redirection function; and
a client apparatus controlled by the server apparatus,
wherein:
the client apparatus transmits information about the content to the server apparatus when a local storage storing a content is connected to the client apparatus;
the server apparatus generates a content play command corresponding to the content based on the information about the content and transmits the content play command to the client apparatus; and
the client apparatus plays and outputs the content stored in the local storage when the content play command is received.

6. The multimedia redirection system of claim 5, wherein:
the client apparatus automatically extracts the information about the content and transmits the information to the server apparatus when the local storage is connected to the client apparatus; and
the server apparatus automatically extracts the content play command and transmits the extracted content play command to the client apparatus when the information about the content is received.

7. The multimedia redirection system of claim 6, wherein the client apparatus displays a user interface (UI) screen displaying the content information stored in the local storage when the local storage is connected and transmits the content information to the server apparatus when a user play command with respect to the content is input on the UI screen.

8. A multimedia redirection method in a multimedia redirection system, the multimedia redirection method comprising:
detecting information about a client content through a client apparatus when the client local storage storing the client content is connected to the client apparatus;
transmitting the information from the client apparatus to a server apparatus;
generating a play command with respect to the client content based on the information through the server apparatus;
transmitting the play command from the server apparatus to the client apparatus; and
playing the client content according to the play command through the client apparatus.

9. A multimedia redirection method of a client apparatus, the multimedia redirection method comprising:
detecting information about a client content when a client local storage storing the client content is connected to the client apparatus;
transmitting the information to a server apparatus that supports a multimedia redirection function;
receiving a content play command corresponding to the information from the server apparatus; and
processing and outputting the client content according to the content play command.

10. A multimedia redirection method of a server apparatus which supports a multimedia redirection function, the multimedia redirection method comprising:
receiving information about a content from a client apparatus to which a client local storage storing the content is connected;
generating a content play command corresponding to the content based on the information about the content; and
transmitting the content play command to the client apparatus.

11. The multimedia redirection system of claim 1, wherein the server apparatus and the client apparatus are connected by a network.

12. The client apparatus of claim 1, wherein if new content is stored in the client local storage connected to the connector, the client controller automatically extracts the information about the new content and transmits the extracted information to the server apparatus.

13. The server apparatus claim 4, wherein an operating system required by the client apparatus is installed in the server apparatus, and the server apparatus controls the client apparatus by way of the installed operating system.

14. The multimedia redirection system of claim 5, wherein an operating system required by the client apparatus is installed in the server apparatus, and the server apparatus controls the client apparatus by way of the installed operating system.

15. The multimedia redirection system of claim 5, wherein the server apparatus and the client apparatus are connected by a network.

16. The multimedia redirection system of claim 15, wherein the network is an IP network.

17. The multimedia redirection system of claim 5, wherein the content play command comprises at least one of a file name of an object to be played, a position coordinate value to display a content play screen, a decoding method, a color attribute value and resolution information.

18. A client apparatus comprising:
a client interface which communicates with a server apparatus that supports a multimedia redirection function;
a controller which transmits information about a client content to the server apparatus and processes the client content as a form that is output when a play command with respect to the client content is received from the server apparatus; and
an output unit which outputs the processed client content.

19. The client apparatus of claim 18, wherein the client controller transmits the client content information to the server apparatus when a user play command with respect to the client content is input.

20. The client apparatus of claim 18, wherein the client controller automatically extracts the information about the client content and transmits the extracted information to the server apparatus.
